(19) United States
(12) Patent Application Publication
(10) Pub. No.: US 2025/0287443 A1
(43) Pub. Date: Sep. 11, 2025

(54) MULTI-MODAL SESSION ACTIVATION FOR MULTI-MODAL EXTENDED REALITY (XR) USER EQUIPMENT (UEs)

(71) Applicant: QUALCOMM Incorporated, San Diego, CA (US)

(72) Inventors: Diana MAAMARI, San Diego, CA (US); Prasad Reddy KADIRI, San Diego, CA (US); Dario Serafino TONESI, San Diego, CA (US); Sebastian SPEICHER, Wallisellen (CH); Umesh PHUYAL, San Diego, CA (US); Mickael MONDET, Louannec (FR); Sitaramanjaneyulu KANAMARLAPUDI, San Diego, CA (US)

(21) Appl. No.: 18/599,034

(22) Filed: Mar. 7, 2024

(51) Int. Cl. H04W 76/15; H04W 68/02; H04W 76/18

(52) U.S. Cl. CPC H04W 76/15; H04W 68/02; H04W 76/18

(57) ABSTRACT

A method for wireless communication at an extended reality (XR) user equipment (UE) includes receiving an XR multi-modal group page associated with a group multi-modal paging identifier (ID) for a group of XR UEs including the XR UE. The group of XR UEs has a same multi-modal service ID. The method also includes transmitting an uplink message for radio resource control (RRC) setup of a deactivated multi-modal session, in response to receiving the XR multi-modal group page. The multi-modal session includes a set of distinct data flows for a same multi-modal service. A method of wireless communication at a network device includes generating a multi-modal paging ID based on a multi-modal service ID assigned to a group of XR UEs. The method also includes initiating a group page of inactive mode or idle mode XR UEs having the multi-modal paging ID.

### FIELD OF THE DISCLOSURE

The present disclosure relates generally to wireless communications, and more specifically to multi-modal session activation for multi-modal extended reality (XR) user equipment (UEs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication at an extended reality (XR) user equipment (UE) includes receiving an XR multi-modal group page associated with a group multi-modal paging identifier (ID) for a group of XR UEs including the XR UE. The group of XR UEs has a same multi-modal service ID. The method also includes transmitting an uplink message for radio resource control (RRC) setup of a deactivated multi-modal session, in response to receiving the XR multi-modal group page. The multi-modal session includes a set of distinct data flows for a same multi-modal service.

In other aspects of the present disclosure, a method of wireless communication at a network device includes generating a multi-modal paging identifier (ID) based on a multi-modal service ID assigned to a group of extended reality (XR) user equipment (UEs). The method also includes initiating a group page of inactive mode or idle mode XR UEs having the multi-modal paging ID.

Other aspects of the present disclosure are directed to an apparatus. The apparatus has one or more memories and one or more processors coupled to the one or more memories. The processor(s) is configured to generate a multi-modal paging identifier (ID) based on a multi-modal service ID assigned to a group of extended reality (XR) user equipment (UEs). The processor(s) is also configured to initiate a group page of inactive mode or idle mode XR UEs having the multi-modal paging ID.

Other aspects of the present disclosure are directed to an apparatus. The apparatus has one or more memories and one or more processors coupled to the one or more memories. The processor(s) is configured to receive an XR multi-modal group page associated with a group multi-modal paging identifier (ID) for a group of XR UEs including the XR UE. The group of XR UEs has a same multi-modal service ID. The processor(s) is also configured to transmit an uplink message for radio resource control (RRC) setup of a deactivated multi-modal session, in response to receiving the XR multi-modal group page. The multi-modal session includes a number of distinct data flows for a same multi-modal service.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a diagram illustrating a split extended reality (XR) architecture, in accordance with various aspects of the present disclosure.

FIG. 5 is a diagram illustrating an immersive multi-modal virtual reality (VR) application with multiple UEs, in accordance with various aspects of the present disclosure.

FIG. 6 is a call flow diagram illustrating multi-modal session activation, in accordance with aspects of the present disclosure.

FIG. 7 is a flow diagram illustrating an example process performed, for example, by an extended reality (XR) UE, in accordance with various aspects of the present disclosure.

FIG. 8 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Fifth generation (5G), sixth generation (6G), and later wireless cellular communication standards enable high-speed, low-latency, high-reliability wireless connectivity. These standards enable latency sensitive services, such as immersive extended reality (XR) multimedia and cloud computing. For example, augmented reality (AR) glasses, virtual reality (VR) head-mounted displays (HMDs), cloud gaming, and cloud artificial intelligence (AI) may be enabled. These advanced applications should meet strict system specifications for data rate, latency, and power consumption. Low latency plus high reliability specifications may dictate that 99% of XR traffic packets should be delivered within a packet delay budget (PDB) requirement, for example, ten milliseconds (10 ms). Because mobile devices operate in cellular networks, cellular mobility procedures may significantly increase the packet delay of real-time multimedia traffic. For a good immersive experience, data from multi-modal flows should be received by user equipment (UEs) within synchronization thresholds. Otherwise, the XR user will notice asynchrony.

For multi-modality, enhancements for XR applications have been introduced to support multiple quality of service (QOS) flows associated with the same protocol data unit (PDU) session for inter and intra UE communications. A new multi-modal service identifier (ID) has been introduced. The multi-modal service ID associates multiple UEs in a same multi-modal session. The multi-modal service ID associates different flows to the same multi-modal service.

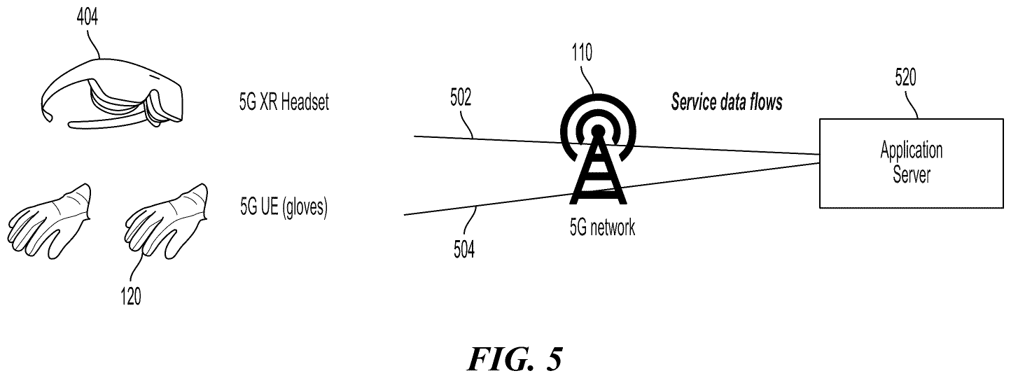

Aspects of the present disclosure introduce multi-modality enhancements. In these aspects, an XR multi-modal service consists of multiple quality of service (QOS) flows (for example, the service data flows 502, 504 of FIG. 5) targeting different UEs (for example, the XR headset 404 and gloves 120 of FIG. 5). For a complete immersive experience, the two UEs should be engaged in the same multi-modal session. The two UEs have PDUs or PDU sets to be delivered within a synchronization threshold, which is the basis of multi-modality. Failing to meet the synchronization threshold causes the user of the UEs to notice asynchrony.

Aspects of the present disclosure propose that groups of UEs having a same multi-modal service ID are paged as one group, rather than separately. If a service has multiple UEs and only a subset of the UEs are to be paged, the new paging techniques accommodate different group paging IDs that differentiate subsets of UEs in the same group. In these aspects, the data traffic is not multicast traffic, and therefore interworks independently from multicast. Each UE receives a separate data stream. More specifically, the UEs do not share data transmissions, that is, no multicast or broadcast users are present.

According to aspects of the present disclosure, instead of having the access and mobility management function (AMF) send separate paging message(s) to the radio access network (RAN) node(s) for each UE in a multi-modal session, the AMF transmits XR multi-modal group paging with a group multi-modal ID for a group of XR UEs. These aspects account for the multi-modal XR UEs that are involved in the multi-modal sessions and identified by a multi-modal service ID.

A new XR group paging ID is introduced. This multi-modal paging ID is configured to UEs in advance when an XR group multi-modal session is set up. The multi-modal paging ID is unique across the RAN nodes where the paging occurs. As a result of the new multi-modal paging ID, an AMF may page a group of XR multi-modal UEs in a single multi-modal session, rather than paging separately on a per UE basis, to wake up all UEs belonging to the group ID.

An example of XR multi-modal session activation is now described. When multi-modal XR downlink (DL) traffic arrives, and this downlink data consists of multiple QoS flows for a same multi-modal service and a multi-modal group session is in a deactivated state, the core network initiates an XR multi-modal session activation procedure. The downlink data, for example, may be haptic data and video data for an XR head mounted display (HMD) and XR gloves or for different XR users or players with a same multi-modal service. If any joined UEs are in idle mode, multi-modal XR group paging is sent to the UEs via the radio access network (for example, base station). Multi-modal paging may also be sent to UEs in inactive mode.

Particular aspects of the subject matter described in this disclosure can be implemented to realize one or more of the following potential advantages. In some examples, the described techniques, such as XR group multi-modal paging may improve signaling efficiency and enable group confirmation.

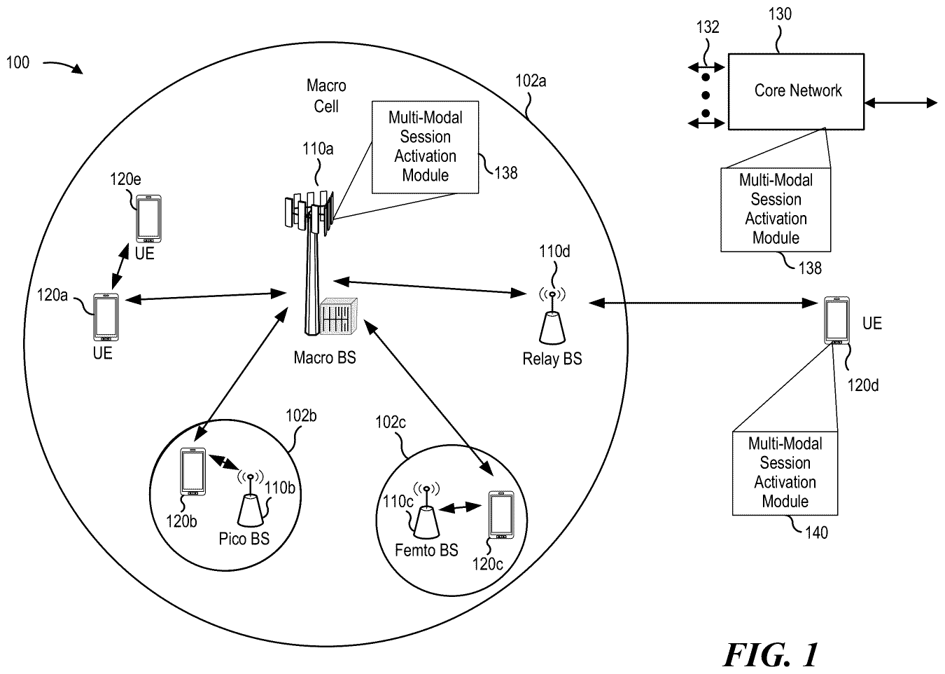

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a multi-modal session activation module 140. For brevity, only one UE 120d is shown as including the multi-modal session activation module 140. The multi-modal session activation module 140 may receive an XR multi-modal group page associated with a group multi-modal paging identifier (ID) for a group of XR UEs including the XR UE. The group of XR UEs has a same multi-modal service ID. The multi-modal session activation module 140 may also transmit an uplink message for radio resource control (RRC) setup of a deactivated multi-modal session, in response to receiving the XR multi-modal group page, the multi-modal session comprising a set of distinct data flows for a same multi-modal service.

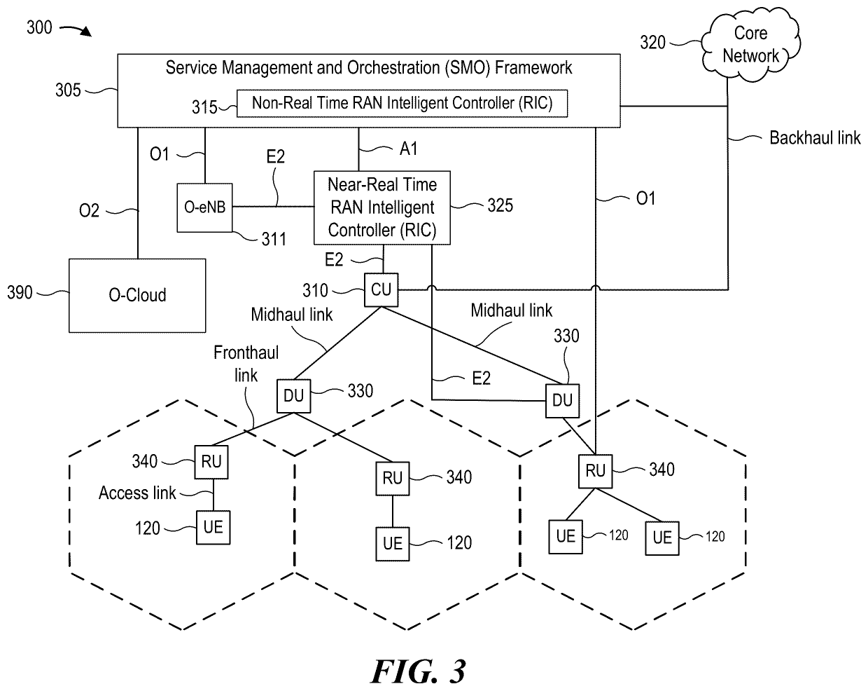

The core network 130 or the base stations 110 or any other network device (e.g., as seen in FIG. 3) may include a multi-modal session activation module 138. For brevity, only one base station 110a is shown as including the multi-modal session activation module 138. The multi-modal session activation module 138 may generate a multi-modal paging identifier (ID) based on a multi-modal service ID assigned to a group of extended reality (XR) user equipment (UEs). The multi-modal session activation module 138 may also initiate a group page of inactive mode or idle mode XR UEs having the multi-modal paging ID.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

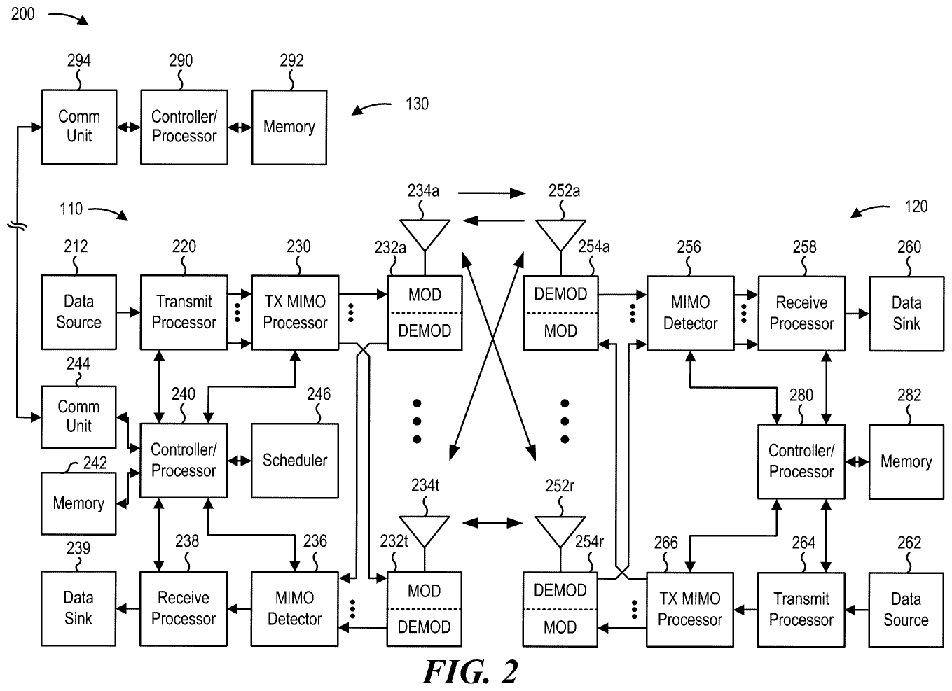

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

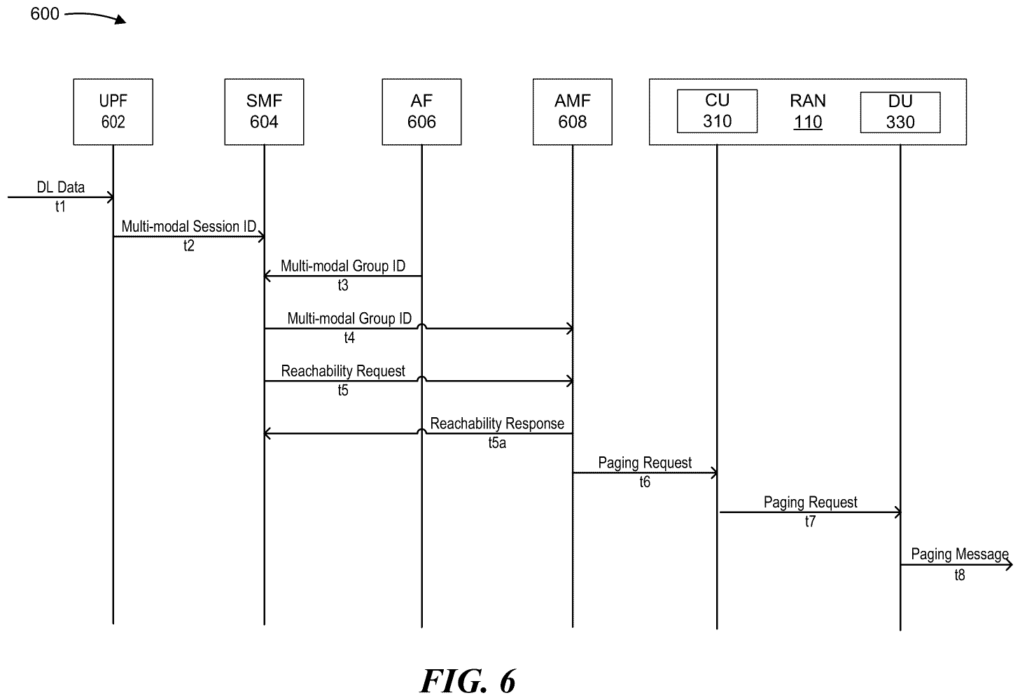

The controller/processor 240 of the base station 110, the controller/processor 280 of the UE 120, and/or any other component(s) of FIG. 2 may perform one or more techniques associated with multi-modal session activation, as described in more detail elsewhere. For example, the controller/processor 240 of the base station 110, the controller/processor 280 of the UE 120, and/or any other component(s) of FIG. 2 may perform or direct operations of, for example, the processes of FIGS. 6-8 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for transmitting, means for awakening, means for generating, means for initiating, means for informing, and means for mapping. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Fifth generation (5G), sixth generation (6G), and later wireless cellular communication standards enable high-speed, low-latency, high-reliability wireless connectivity. These standards enable latency sensitive services, such as immersive extended reality (XR) multimedia and cloud computing. For example, augmented reality (AR) glasses, virtual reality (VR) head-mounted displays (HMDs), cloud gaming, and cloud artificial intelligence (AI) may be enabled. These advanced applications should meet strict system specifications for data rate, latency, and power consumption. Low latency plus high reliability specifications may dictate that 99% of XR traffic packets should be delivered within a packet delay budget (PDB) requirement, for example, ten milliseconds (10 ms). Because mobile devices operate in cellular networks, cellular mobility procedures may significantly increase the packet delay of real-time multimedia traffic.

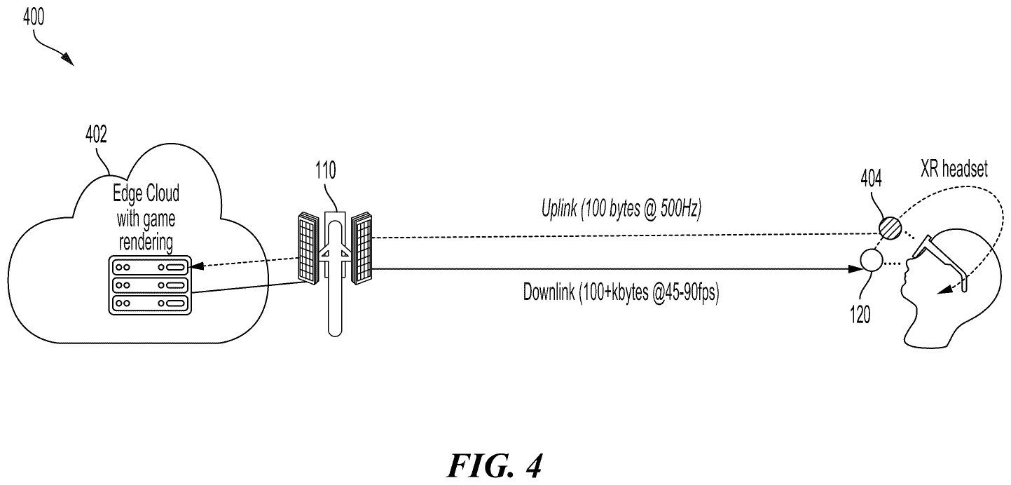

FIG. 4 is a diagram illustrating a split extended reality architecture 400, in accordance with various aspects of the present disclosure. In the example of FIG. 4, a base station 110 communicates with an edge cloud 402. The edge cloud 402 may include processors for game rendering or other functionalities. The base station 110 also communicates with multiple UEs including a mobile device 120 and an XR headset 404. The mobile device 120 receives downlink communications from the base station 110, for example, packets carrying more than 100 kilobytes (KB) of data for rendering at 45-90 frames per second (FPS). The XR headset 404 transmits uplink communications to the base station 110, for example, packets carrying 100 bytes of data for processing at 500 hertz (Hz). Cellular mobility procedures should be able to accommodate the specifications for the uplink and downlink data in order to provide a good immersive experience for the user.

FIG. 5 is a diagram illustrating an immersive multi-modal virtual reality (VR) application with multiple UEs, in accordance with various aspects of the present disclosure. In the example of FIG. 5, the UEs include an XR headset 404 (also referred to as a head mounted display (HMD)) and gloves 120, which are separate UEs that may belong to a single multi-modal service. For example, tactile (e.g., gloves 120) and multi-modal communication services (e.g., XR headset 404) may enable multi-modal interactions, combining ultra-low latency with extremely high availability, reliability and security. An application server 520 (e.g., the edge cloud 402 shown in FIG. 4) communicates with the gloves 120 and XR headset 404 via separate service data flows 502, 504. Immersive multi-modal virtual reality (VR) applications including these UEs 120, 404 may be supported. For a good immersive experience, data from multi-modal flows should be received by the UEs 120, 404 within synchronization thresholds. Otherwise, the XR user will notice asynchrony.

For example, for audio-tactile UE combinations, packet data unit (PDU) sets of tactile data can arrive no later than 50 ms from when audio data arrives. Any tactile delay should be no longer than 25 ms relative to the audio data. For visual-tactile UE combinations, the visual delay should be no longer than 15 ms after the tactile data. The tactile delay should be no longer than 50 ms after the visual data. For each media component, delay refers to the case where a media component is delayed compared to another media component.

For multi-modality, enhancements for XR applications have been introduced to support multiple quality of service (QOS) flows associated with the same PDU session for inter and intra UE communications. A new multi-modal service identifier (ID) has been introduced. The multi-modal service ID associates multiple UEs in a same multi-modal session. The multi-modal service ID supports both single and multi-UE cases in the same multi-modal session. The multi-modal service ID associates different flows to the same multi-modal service. For a single UE case, the data flows are closely related and specify strong application coordination for proper execution of the multi-modal application. Thus, all the data flows are transmitted in a single session. The policy control function (PCF) may use the multi-modal service ID to derive policy and charging control (PCC) rules to enforce a similar packet delay budget (PDB) for the different flows, ensuring synchronization thresholds are satisfied. The same multi-modal service ID may be allocated to all UE PDU sessions used by the multi-modal service.

Aspects of the present disclosure introduce multi-modality enhancements. In these aspects, an XR multi-modal service consists of multiple QoS flows (for example the service data flows 502, 504 of FIG. 5) targeting different UEs (for example, the XR headset 404 and gloves 120 of FIG. 5). For a complete immersive experience, the two UEs should be engaged in the same multi-modal session. The two UEs have PDUs or PDU sets to be delivered within a synchronization threshold, which is the basis of multi-modality. Failing to satisfy the synchronization threshold causes the user of the UEs to notice asynchrony.

Aspects of the present disclosure propose that groups of UEs having a same multi-modal service ID are paged as one group, rather than separately. If a service has multiple UEs and only a subset of the UEs are to be paged, the new paging techniques accommodate different group paging IDs that differentiate subsets of UEs in the same group. In these aspects, the data traffic is not multicast traffic, and therefore interworks independently from multicast. Each UE receives a separate data stream. More specifically, the UEs do not share data transmissions, that is, no multicast or broadcast users are present.

Aspects of the present disclosure introduce procedures for XR multi-modal session activation for a group of XR UEs associated with a same multi-modal service or service that has a unique multi-modal service ID. As noted above, the multi-modal service specifies a group of UEs to be activated or paged simultaneously for a complete immersive experience. Moreover, the PDUs of each of the XR UEs has to be delivered within a synchronization threshold.

According to aspects of the present disclosure, instead of having the access and mobility management function (AMF) send separate paging message(s) to the radio access network (RAN) node(s) for each UE in a multi-modal session, the AMF transmits XR multi-modal group paging with a group multi-modal ID for a group of XR UEs. These aspects account for the multi-modal XR UEs that are involved in the multi-modal sessions and identified by a multi-modal service ID.

A new XR group paging ID is introduced. This multi-modal paging ID is configured to UEs in advance when an XR group multi-modal session is set up. The multi-modal paging ID is unique across the RAN nodes where the paging occurs. As a result of the new multi-modal paging ID, an AMF may page a group of XR multi-modal UEs in a single multi-modal session, rather than paging separately on a per UE basis, to wake up all UEs belonging to the group ID. Thus, efficient signaling occurs and a group confirmation becomes possible.

Aspects of XR multi-modal session activation are now described. When multi-modal XR downlink (DL) traffic arrives, and this downlink data consists of multiple QoS flows for a same multi-modal service and a multi-modal group session is in a deactivated state, the core network 130 (see FIG. 1) initiates the XR multi-modal session activation procedure. The downlink data, for example, may be haptic data and video data for the XR headset 404 and XR gloves 120 or for different XR users or players with a same multi-modal service. If any joined UEs are in radio resource control idle (RRC_IDLE) mode, multi-modal XR group paging is sent to the UEs via the RAN 110 (see FIG. 1). Multi-modal paging may also be sent to UEs in RRC_INACTIVE mode.

Currently, the multi-modal service ID is only visible to the application function (AF), network exposure function (NEF), and policy control function (PCF). Aspects of the present disclosure introduce techniques for informing the AMF or session management function (SMF) of the multi-modality ID. In other aspects, an equivalent multi-modal group paging ID is introduced.

In some aspects, the PCF informs the UE of the multi-modal service ID or any equivalent multi-modal ID. For example, the PCF may signal the information to the SMF, which signals the information to the UE during a PDU session establishment or modification. The AMF receives the multi-modal service ID and maps the multi-modal service ID to the paging area. The SMF provides the AMF with the multi-modal service ID at PDU session establishment or modification. A group of multi-modality UEs or a subset of the group also learn about this group ID from the AMF during registration or the PDU setup procedure.

Details of an example signaling flow are now described with respect to FIG. 6. FIG. 6 is a call flow diagram 600 illustrating multi-modal session activation, in accordance with aspects of the present disclosure. At time t1, a user plane function (UPF) 602 receives multi-modal downlink (DL) data for a multi-modal XR session. The multi-modal session may include, for example, XR multi-modal inter-UE activity involving 5G gloves 120 and a 5G XR headset 404 discussed with reference to FIGS. 4 and 5. Based on an instruction from a session management function (SMF) 604, at time t2 the UPF 602 sends the multi-modal session ID, via an N4 interface, to the SMF 604 indicating the arrival of the downlink multi-modal XR data. That is, during the initial registration procedure, the SMF send a packet forwarding control protocol (PFCP) session establishment request to the UPF and within that message the SMF instructs the UPF to establish the user plane end points. Once the UPF receives downlink data for that PDU session, the UPF sends a PFCP session report request to the SMF. At time t3, an application function (AF) 606 sends the multi-modal group ID to the SMF 604 directly, or via a network exposure function (NEF) (not shown). The AMF paging transmission is triggered by the SMF. The SMF invokes the AMF, as described later.

After receiving the multi-modal group ID, the SMF 604 sets the related multi-modal session state to active and determines a list of UEs that are part of the multi-modal XR session identified by the multi-modal group ID. If the SMF 604 determines the user plane of the associated PDU session(s) of the UE(s) belonging to the multi-modal session ID is already activated, the next steps are skipped.

If the session(s) is not already active, the SMF 604 transmits new signaling to an access and mobility management function (AMF) 608 at time t5. The new signaling may be referred to as a Namf_multimodalGroupReachability Request and includes a list of UEs associated with the multi-modal ID. The list may include all UEs or only a subset of UEs associated with the multi-modal ID. The reachability request also includes a PDU session ID(s) of the PDU session(s) associated with the multi-modal ID. The reachability request ensures the UEs are reachable to be paged.

If there are UEs involved in the XR multi-modal session that are in CONNECTED state, the AMF 608 indicates those UEs to the SMF 604, at time t5a, in a reachability response. The reachability response may be in the form of new signaling referred to as a Namf_multimodalGroupReachability Response, and may include a list of UEs in the CONNECTED state. The CONNECTED mode UEs do not need paging. If there are no CONNECTED mode UEs, the response does not include a UE list.

If the AMF 608 determines there are UEs in idle or inactive state and involved in the multi-modal session, the AMF 608 determines the paging area covering all the registration areas of those UE(s) to be paged. The AMF 608 sends a multi-modal group paging request to a radio access network (RAN) 110, at time t6, via a next-generation application protocol (NGAP) interface. The NGAP paging request may include either a new XR specific multi-modal group paging ID or a new XR multi-modal group paging message including a new XR specific multi-modal group paging ID message and multi-modal ID identifying the UEs to be paged. The RAN 110 may include all next generation (NG)-RAN node(s) belonging to the multi-modal paging area of the UEs in the UE list.

Upon receiving the NGAP paging message, a central unit-control plane (CU-CP) 310 transmits a paging request message to a distributed unit (DU) 330, at time t7. The message may be either an existing F1 application protocol (F1-AP) multicast group paging request including the new XR specific multi-modal group paging ID or a new F1-AP XR multi-modal group paging message including the new XR specific multi-modal group paging ID.

For communication between NG-RAN nodes 110 (only one node shown) via the Xn-AP interface, the CU-CP 310 transmits a message to neighbor CU-CPs (not shown) belonging to the multi-modal paging area of the listed UEs. The message may be either an existing Xn-AP multicast group paging request including the new XR specific multi-modal group paging ID or a new Xn-AP XR multi-modal group paging message including the new XR specific multi-modal group paging ID.

At time t8, the DU 330 transmits a legacy radio resource control (RRC) paging message by including the new XR specific multi-modal group paging ID as a new paging record for paging over the radio air interface. To facilitate the paging, the multi-modal XR UEs have a common discontinuous reception (DRX) configuration.

As discussed above, there can be two options, either 1) a new paging message; or 2) a legacy paging message enhanced with group paging. If a new paging message is invoked, then a multi-modal XR specific radio network temporary identifier (RNTI) for paging may be introduced.

According to aspects of the present disclosure, upon reception of the multi-modal group paging associated with an XR multi-modal session, the UEs being paged respond via the uplink (UL) for RRC setup, similar to unicast communications. Thus, while the paging is group based, the action from the UE is unicast. Moreover, each XR UE receives different data from the other XR UEs. For example, the gloves 120 may receive tactile data, whereas the XR headset 404 may receive graphics data.

In further aspects of the present disclosure, UEs may receive multi-modal specific system information modifications in a short message as part of the group multi-modal page.

In still other aspects, UEs may trigger RRC setup. For example, UEs may trigger random access channel (RACH) messages in dedicated random access channel occasions (ROs) or preambles. One anchor UE of a multi-modal group may send uplink messages on behalf of other UEs. Moreover, UEs may optionally wake up each other for enhanced reliability. Thus, even though the paging is for a group, the action at the UE side resembles unicast transmissions.

Aspects of the present disclosure map the existing multi-modal service ID to a unique group common identifier at the RAN and at the engaged multi-modal UEs or subset of the engaged multi-modal UEs. Moreover, new signaling has been introduced, including a Namf_multimodalGroupReachability Request, and a Namf_multimodalGroupReachability Response. Finally, multi-modal group signaling may include a multicast group paging request, as well as signaling to reach the RAN and the UEs.

As indicated above, FIGS. 3-6 are provided as examples. Other examples may differ from what is described with respect to FIGS. 3-6.

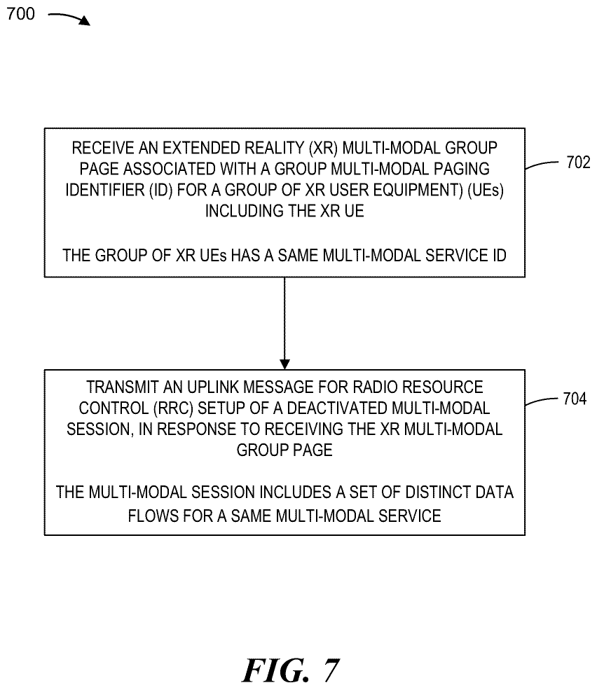

FIG. 7 is a flow diagram illustrating an example process 700 performed, for example, by an extended reality (XR) user equipment (UE), in accordance with various aspects of the present disclosure. The example process 700 is an example of multi-modal session activation for multi-modal extended reality (XR) user equipment (UEs). The operations of the process 700 may be implemented by a UE 120.

At block 702, the user equipment (UE) receives an XR multi-modal group page associated with a group multi-modal paging identifier (ID) for a group of XR UEs including the XR UE. The group of XR UEs has a same multi-modal service ID. For example, the UE (e.g., using the antenna 252, DEMOD/MOD 254, MIMO detector 256, receive processor 258, controller/processor 280, memory 282, and/or the like) may receive the XR multi-modal group page. In some aspects, the UE may receive an indication of the group multi-modal paging ID during a packet data unit (PDU) session establishment or a PDU session modification.

At block 704, the user equipment (UE) transmits an uplink message for radio resource control (RRC) setup of a deactivated multi-modal session, in response to receiving the XR multi-modal group page. The multi-modal session includes a set of distinct data flows for a same multi-modal service. For example, the UE (e.g., using the antenna 252, MOD/DEMOD 254, TX MIMO processor 266, transmit processor 264, controller/processor 280, memory 282, and/or the like) may transmit the uplink message. In some aspects, the UE transmits the uplink message on behalf of another XR UE of the group of XR UEs.

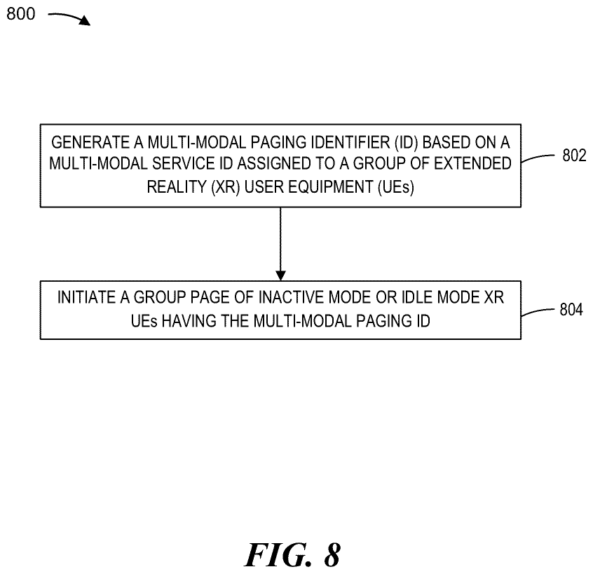

FIG. 8 is a flow diagram illustrating an example process 800 performed, for example, by a network device, in accordance with various aspects of the present disclosure. The example process 800 is an example of multi-modal paging. The operations of the process 800 may be implemented by a base station 110.

At block 802, the base station generates a multi-modal paging identifier (ID) based on a multi-modal service ID assigned to a group of extended reality (XR) user equipment (UEs). For example, the base station (e.g., using the controller/processor 240, memory 242, and/or the like) may generate the multi-modal paging ID. In some aspects, the network device informs the group of XR UEs of the multi-modal paging ID during setup of a multi-modal session.

At block 804, the base station initiates a group page of inactive mode or idle mode XR UEs having the multi-modal paging ID. For example, the base station (e.g., using the controller/processor 240, memory 242, and/or the like) may initiate the group page. In some aspects, the network device initiates the group page via a multicast group paging request including the multi-modal paging ID. In other aspects, the network device initiates the group page via a multi-modal group paging message including the multi-modal paging ID. In still other aspects, the network device may initiate the group page with a multi-modal XR specific radio network temporary ID (RNTI).

### EXAMPLE ASPECTS

Aspect 1: A method of wireless communication at an extended reality (XR) user equipment (UE), comprising: receiving an XR multi-modal group page associated with a group multi-modal paging identifier (ID) for a group of XR UEs including the XR UE, the group of XR UEs having a same multi-modal service ID; and transmitting an uplink message for radio resource control (RRC) setup of a deactivated multi-modal session, in response to receiving the XR multi-modal group page, the multi-modal session comprising a plurality of distinct data flows for a same multi-modal service.

Aspect 2: The method of Aspect 1 further comprising receiving an indication of the group multi-modal paging ID during a packet data unit (PDU) session establishment or a PDU session modification.

Aspect 3: The method of Aspect 1 or 2, further comprising transmitting the uplink message on behalf of another XR UE of the group of XR UEs.

Aspect 4: The method of any of the preceding Aspects, further comprising awakening another XR UE of the group of XR UEs in response to receiving the XR multi-modal group page.

Aspect 5: A method of wireless communication at a network device, comprising: generating a multi-modal paging identifier (ID) based on a multi-modal service ID assigned to a group of extended reality (XR) user equipment (UEs); and initiating a group page of inactive mode or idle mode XR UEs having the multi-modal paging ID.

Aspect 6: The method of Aspect 5, further comprising informing the group of XR UEs of the multi-modal paging ID during setup of a multi-modal session.

Aspect 7: The method of Aspect 5 or 6, further comprising mapping a paging area to the multi-modal service ID.

Aspect 8: The method of any of the Aspects 5-7, further comprising receiving a multi-modal session ID from a user plane function (UPF) in response to the UPF receiving multi-modal downlink data for a multi-modal extended reality (XR) session.

Aspect 9: The method of any of the Aspects 5-8, further comprising initiating the group page via a multicast group paging request including the multi-modal paging ID.

Aspect 10: The method of any of the Aspects 5-8, further comprising initiating the group page via a multi-modal group paging message including the multi-modal paging ID.

Aspect 11: The method of any of the Aspects 5-8, further comprising initiating the group page with a multi-modal XR specific radio network temporary ID (RNTI).

Aspect 12: The method of any of the Aspects 5-11, further comprising transmitting a multi-modal group reachability request to determine whether the inactive mode or idle mode XR UEs are reachable via paging.

Aspect 13: An apparatus for wireless communication at a network device, comprising: at least one memory; and at least one processor coupled to the at least one memory, the at least one processor configured: to generate a multi-modal paging identifier (ID) based on a multi-modal service ID assigned to a group of extended reality (XR) user equipment (UEs); and to initiate a group page of inactive mode or idle mode XR UEs having the multi-modal paging ID.

Aspect 14: The apparatus of Aspect 13, in which the at least one processor is further configured to inform the group of XR UEs of the multi-modal paging ID during setup of deactivated.

Aspect 15: The apparatus of Aspect 13 or 14, in which the at least one processor is further configured to map a paging area to the multi-modal service ID.

Aspect 16: The apparatus of any of the Aspects 13-15, in which the at least one processor is further configured to receive a multi-modal session ID from a user plane function (UPF) in response to the UPF receiving multi-modal downlink data for a multi-modal extended reality (XR) session.

Aspect 17: The apparatus of any of the Aspects 13-16, in which the at least one processor is further configured to initiate the group page via a multicast group paging request including the multi-modal paging ID.

Aspect 18: The apparatus of any of the Aspects 13-16, in which the at least one processor is further configured to initiate the group page via a multi-modal group paging message including the multi-modal paging ID.

Aspect 19: The apparatus of any of the Aspects 13-16, in which the at least one processor is further configured to initiate the group page with a multi-modal XR specific radio network temporary ID (RNTI).

Aspect 20: The apparatus of claim any of the Aspects 13-19, in which the at least one processor is further configured to transmit a multi-modal group reachability request to determine whether the inactive mode or idle mode XR UEs are reachable via paging.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication at an extended reality (XR) user equipment (UE), comprising:
receiving an XR multi-modal group page associated with a group multi-modal paging identifier (ID) for a group of XR UEs including the XR UE, the group of XR UEs having a same multi-modal service ID; and
transmitting an uplink message for radio resource control (RRC) setup of a deactivated multi-modal session, in response to receiving the XR multi-modal group page, the deactivated multi-modal session comprising a plurality of distinct data flows for a same multi-modal service.

2. The method of claim 1, further comprising receiving an indication of the group multi-modal paging ID during a packet data unit (PDU) session establishment or a PDU session modification.

3. The method of claim 1, further comprising transmitting the uplink message on behalf of another XR UE of the group of XR UEs.

4. The method of claim 1, further comprising awakening another XR UE of the group of XR UEs in response to receiving the XR multi-modal group page.

5. A method of wireless communication at a network device, comprising:
generating a multi-modal paging identifier (ID) based on a multi-modal service ID assigned to a group of extended reality (XR) user equipment (UEs); and
initiating a group page of inactive mode or idle mode XR UEs having the multi-modal paging ID.

6. The method of claim 5, further comprising informing the group of XR UEs of the multi-modal paging ID during setup of deactivated.

7. The method of claim 5, further comprising mapping a paging area to the multi-modal service ID.

8. The method of claim 5, further comprising receiving a multi-modal session ID from a user plane function (UPF) in response to the UPF receiving multi-modal downlink data for a multi-modal extended reality (XR) session.

9. The method of claim 5, further comprising initiating the group page via a multicast group paging request including the multi-modal paging ID.

10. The method of claim 5, further comprising initiating the group page via a multi-modal group paging message including the multi-modal paging ID.

11. The method of claim 5, further comprising initiating the group page with a multi-modal XR specific radio network temporary ID (RNTI).

12. The method of claim 5, further comprising transmitting a multi-modal group reachability request to determine whether the inactive mode or idle mode XR UEs are reachable via paging.

13. An apparatus for wireless communication at a network device, comprising:
at least one memory; and
at least one processor coupled to the at least one memory, the at least one processor configured:
to generate a multi-modal paging identifier (ID) based on a multi-modal service ID assigned to a group of extended reality (XR) user equipment (UEs); and
to initiate a group page of inactive mode or idle mode XR UEs having the multi-modal paging ID.

14. The apparatus of claim 13, in which the at least one processor is further configured to inform the group of XR UEs of the multi-modal paging ID during setup of deactivated.

15. The apparatus of claim 13, in which the at least one processor is further configured to map a paging area to the multi-modal service ID.

16. The apparatus of claim 13, in which the at least one processor is further configured to receive a multi-modal session ID from a user plane function (UPF) in response to the UPF receiving multi-modal downlink data for a multi-modal extended reality (XR) session.

17. The apparatus of claim 13, in which the at least one processor is further configured to initiate the group page via a multicast group paging request including the multi-modal paging ID.

18. The apparatus of claim 13, in which the at least one processor is further configured to initiate the group page via a multi-modal group paging message including the multi-modal paging ID.

19. The apparatus of claim 13, in which the at least one processor is further configured to initiate the group page with a multi-modal XR specific radio network temporary ID (RNTI).

20. The apparatus of claim 13, in which the at least one processor is further configured to transmit a multi-modal group reachability request to determine whether the inactive mode or idle mode XR UEs are reachable via paging.
